(19) United States
(12) Patent Application Publication
(10) Pub. No.: US 2024/0183945 A1
(43) Pub. Date: Jun. 6, 2024

(54) LIDAR SYSTEM WITH MULTIPLE CHANNEL COUNT

(71) Applicant: Luminar Technologies, Inc., Orlando, FL (US)

(72) Inventors: Daniel Joseph KLEMME, Robbinsdale, MN (US); Daniel Aaron MOHR, St. Paul, MN (US); Paul LEISHER, Livermore, CA (US)

(21) Appl. No.: 18/526,327

(22) Filed: Dec. 1, 2023

Related U.S. Application Data
(60) Provisional application No. 63/385,936, filed on Dec. 2, 2022.

(51) Int. Cl. G01S 7/481

(52) U.S. Cl. CPC G01S 7/4814; G01S 7/4818

(57) ABSTRACT

Implementations described and claimed herein include a LiDAR system with a semiconductor optical amplifier (SOA) configured to receive a light signal from a master-oscillator laser source, the semiconductor optical source including an optical splitter configured to split the light signal into two or more split light signals and two or more respective semiconductor optical amplifiers (SOAs), each SOA configured to receive one of the split light signals and amplify the split light signal.

### CROSS-REFERENCE TO RELATED APPLICATIONS

This application is a non-provisional application based on and takes priority from pending U.S. provisional application Ser. No. 63/385,936, entitled “Lidar System with Multiple Channel Count,” which was filed on Dec. 2, 2022. The disclosure set forth in the referenced application is incorporated herein by reference in its entirety.

### BACKGROUND

Light detection and ranging (LiDAR) technology measures a distance to an object by projecting a laser toward the object and receiving the reflected laser. In various implementation of LiDAR systems, a light source illuminates a scene. The light scattered by the objects of the scene is detected by a photodetector or an array of photodetectors. By measuring the time it takes for light to travel to the object and return from it, the distance may be calculated. A LiDAR system may use a number of different ranging methods, including pulsed time of flight, phase shift, and frequency modulation.

### SUMMARY

Implementations described and claimed herein include a LiDAR system with a semiconductor optical amplifier (SOA) configured to receive a light signal from a master-oscillator laser source, the semiconductor optical source including an optical splitter configured to split the light signal into two or more split light signals and two or more respective semiconductor optical amplifiers (SOAs), each SOA configured to receive one of the split light signals and amplify the split light signal.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following Detailed Description.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components.

FIG. 1 illustrates an example configuration of a coherent LiDAR system using a laser scanner and a coherent receiver.

FIGS. 2a-2g illustrate example implementations of various semi-conductor based amplifiers used in the coherent LiDAR system disclosed herein.

FIG. 3 illustrates an example illustration of the coherent LiDAR system disclosed herein using a bifurcated semiconductor amplifier.

FIG. 4 illustrates an example operations disclosing use of the coherent LiDAR system disclosed herein using bifurcated semiconductor amplifier to increase the channel count.

FIG. 5 illustrates an example processing system that may be useful in implementing the technology described herein.

### DETAILED DESCRIPTIONS

Light detection and ranging (LiDAR) is a process for measuring distances. For example, energy such as laser light can be directed toward a target object, and the energy reflected by the target object can be detected and measured by a sensor or detector. The distance to the target object can be calculated based on the speed of the light and the time it takes for energy to travel to the target object and back to the sensor. In some cases, LiDAR can use ultraviolet, visible, or near-infrared sources to sense, image, identify, or map objects. In some cases, the sensor uses coherent detection, where a portion of the energy from the laser is separated and made to interfere optically with the energy reflected by the target. In other cases, the sensor may use an incoherent detection scheme, where the return light may be measured directly.

LiDAR systems may include an optical chip or a semi-conductor chip to integrate as much processing as possible so as to reduce cost and complexity of the system. For example, LiDAR systems may include a master oscillator power amplifier (MOPA) style architecture to generate a large amount of power with high optical quality. Here the optical signal may be single mode or narrow linewidth optical signal. An example implementation of MOPA architecture includes a lower power, narrow linewidth laser generator paired with a high-power amplifier stage operated in pulsed, continuous wave (CW), or other mode. An example power amplifier for such implementation may be a semiconductor optical amplifier (SOA). Yet alternatively, the laser generator may be distributed feedback (DFB) laser source of a DFB seed laser source, which for example, may emit laser energy from two ends.

LiDAR systems may include incoherent (or direct energy detection) LiDAR systems and coherent LiDAR systems. The incoherent LiDAR systems generally measure amplitude changes of reflected light. On the other hand, coherent LiDAR systems may use optical heterodyne detection which is generally more sensitive than direct detection and allows them to operate at much lower power. However, such systems require more complex transceivers.

For LiDAR systems, including coherent LiDAR system such as that disclosed herein, it is important to increase the sample rate at which the received laser signal is sampled. The maximum sample rate of the LiDAR systems depends on a number of factors, including the number of laser sources or channels, the number of receivers, etc. The LiDAR system disclosed herein provides a method to increase the number of laser sources or channels to increase the sample rate, with a trivial impact on cost and complexity of the LiDAR system.

LiDAR systems may use an optical amplifier that amplifies an optical signal directly, without the need to first convert it to an electrical signal. Specifically, the LiDAR system disclosed herein may include a bifurcated laser or amplifier system. The amplifier may be a semiconductor optical amplifier SOA or a tapered amplifier (TA). A bifurcated SOA may be an SOA that bifurcates an input laser signal into multiple waveguides to increase the channel count of laser output signals. A TA may be an SOA with a slow, widening, or tapered waveguide to increase gain area and therefore overall output power of the laser signals. A bifurcated TA is an SOA that combines both the bifurcation and the tapering features to increase the channel count of the number of laser signals as well as the output power of the laser signals for each of the output channels.

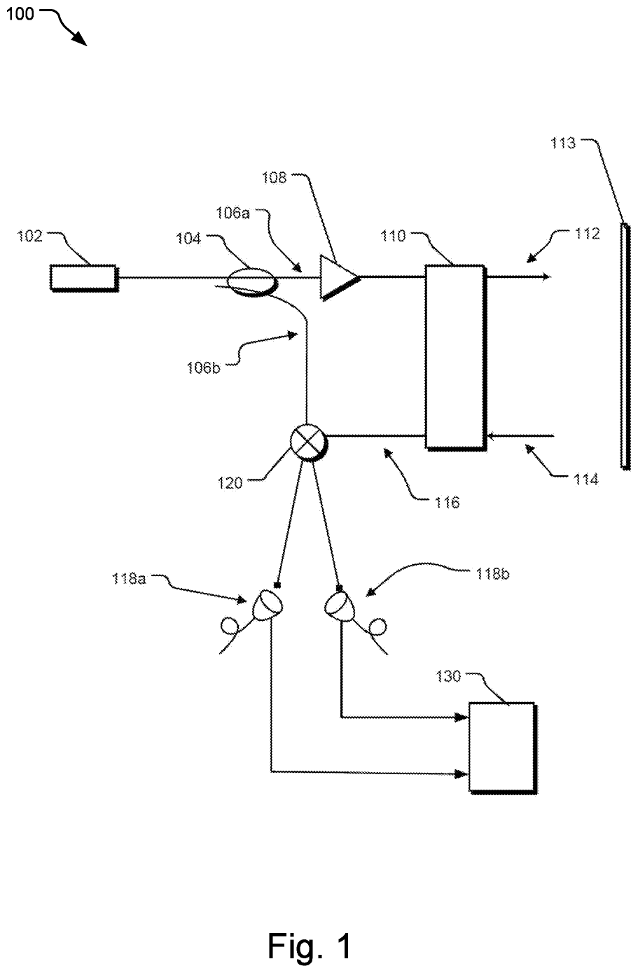

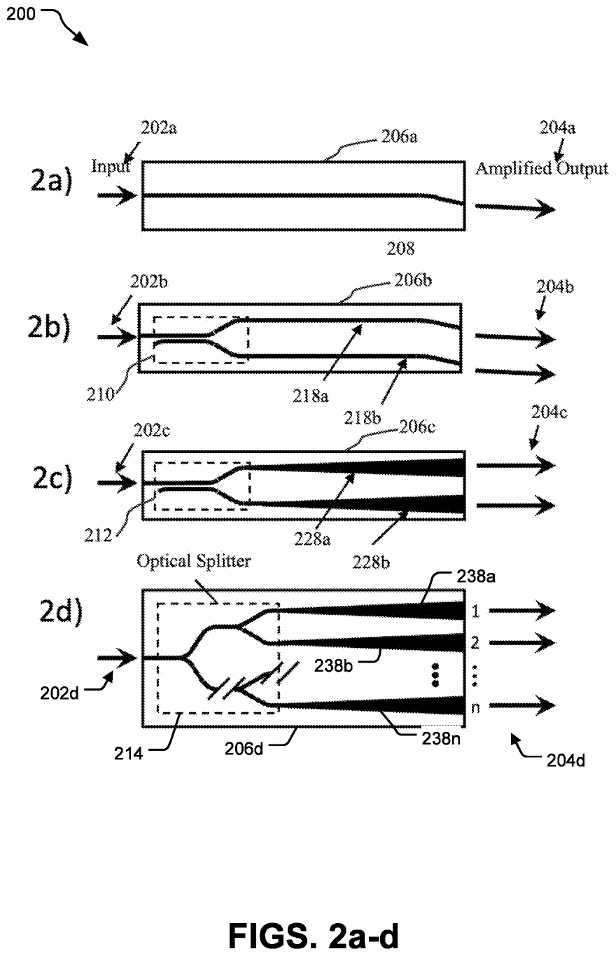

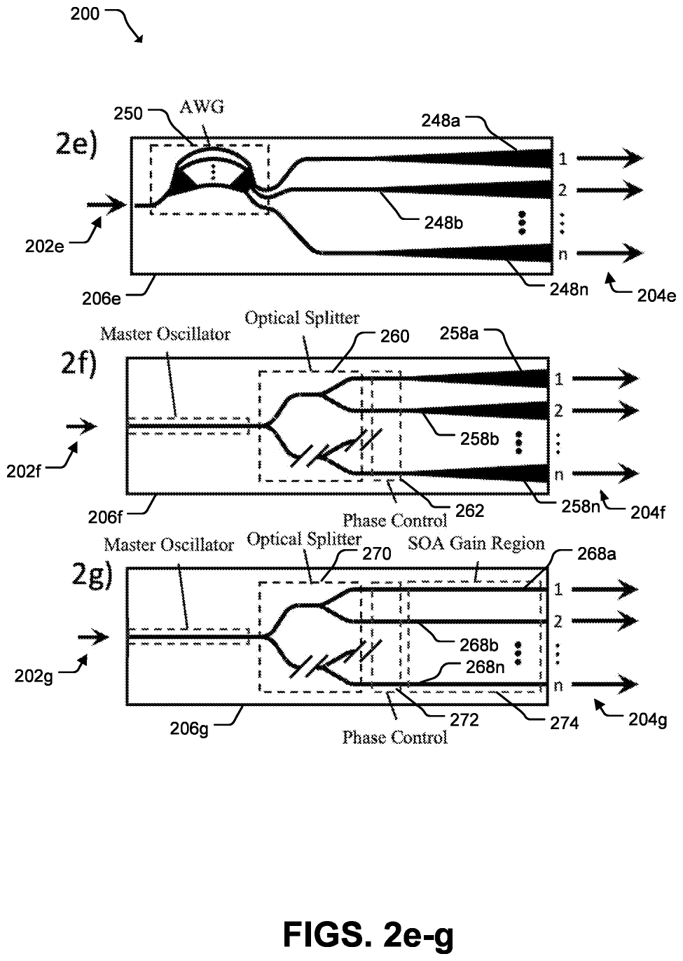

FIG. 1 illustrates an example configuration of a coherent LiDAR system 100 using a laser scanner and a coherent receiver. A laser source 102 generates laser signal that is split by a splitter 104. A portion of the laser signal is split as an amplification stage laser signal 106a to be input to an amplifier 108. Another portion of the laser signal is split as a coherent receiver portion signal 106b to be used by an optical mixer 120. In one implementation of the coherent LiDAR system 100, the amplifier 108 may be a bifurcated amplifier, a tapered amplifier (TA), or a bifurcated TA as disclosed in further detail below in FIG. 2. The laser signal 106a sent through the amplifier 108 increases in power and scanned throughout the field of view/scene using a scanner 110. In one implementation, the scanner 110 may be a polygon scanner.

The scanner 110 projects the scanned laser signal 112 towards a target and 113 de-scans the reflected laser signal 114 that is reflected from the target 113. The optical mixer 120 may receive a signal generated by a local oscillator and the de-scanned laser signal 116 as inputs and generate frequency differential between the two as output. The optical mixer 120 may output an in-phase or I portion and a quadrature or Q portion of the frequency differential so as to maintain the phase information. The output signal from the optical mixer 120 is received by photodiodes 118a and 118b, which converts the optical signal into electrical signal for further processing by a digital signal processing unit 130. The digital signal processing unit 130 processes the input signal received from the photodiodes 118a to determine range information of the target 113.

FIGS. 2a-2g illustrate implementations of various semi-conductor based amplifiers 200 used in the coherent LiDAR system disclosed herein. Specifically, an implementation 2a illustrates a semiconductor optical source 206a with a bent waveguide 208. An input laser signal 202a may be amplified and bent by the waveguide 208 to send a bent and amplified output 204a to a scanner, such as a polygon scanner. An implementation 2b discloses another implementation of a semiconductor optical source 206b that includes a bifurcated and bent waveguides 218a and 218b. Specifically, a bifurcation section 210 bifurcates an input laser signal 202b into the two waveguides or semiconductor optical amplifiers (SOAs) 218a and 218b that generates output laser signals 204b.

While the illustrated implementations of semiconductor optical source 206b discloses two waveguides or SOAs 218a and 218b to divide and bend the input laser signal 202b into two output signals 204b, in alternative implementations, higher number of waveguides may be provided to divide the input laser signal into a larger number of bent output laser signals. The bent waveguides 218a and 218b may reduce reflections from an end facet on a high-power output side of the semiconductor optical source 206b.

The semiconductor optical source 206b may be configured to increase the power of the laser signal traveling through the waveguides or SOAs 218a and 218b. Cost of SOAs depend on its wafer area, wafer material, and complexity of the SOA. Including a number of waveguides into the SOA 206b allows including additional channels for laser signal to travel to a scanner while reducing cost due to wafer material, wafer area, and complexity of the SOA to be lower. For example, a semiconductor wafer used for the semiconductor optical source 206b may be 100 s um wide, while the actual SOA region is on the scale of microns wide. The SOAs disclosed herein utilize the additional room on the wafer for bifurcation of waveguides to increase the channel count.

Another implementation of a semiconductor optical source 206c includes bifurcated and tapered waveguides or SOAs 228a and 228b that bifurcates an input laser signal 202c into the two waveguides 228a and 228b that generates output laser signals 204c. A bifurcation section 212 bifurcates an input laser signal 202c into the two tapered waveguides or SOAs 228a and 228b that generates output laser signals 204c. Each of the waveguides 228a and 228b are tapered to increase the output range of the output laser signal 204c. While the waveguides 228a and 228b are tapered but not bent, in an alternative implementation they may also be bent. Furthermore, while the illustrated implementations of SOA 206c discloses two waveguides 228a and 228b to divide and taper the input laser signal 202c into two output signals 204c, in alternative implementations, higher number of waveguides may be provided to divide the input laser signal into a larger number of tapered output laser signals.

Another implementation of a semiconductor optical source 2d includes an optical splitter that splits the input optical signal 202d towards n different waveguides or SOAs 238a, 238b, . . . 238n that generate output laser signals 204d. The Optical splitter may be at least one of a y-splitter, Mach-Zehnder splitter, multi-mode interferometer (MMI) splitter, wavelength splitter, or selective switching.

Another implementation of a semiconductor optical source 2e that uses wavelength dependent splitting. For example, arrayed waveguide grating (AWG) 250 can also be used to split input light signal 202e between multiple output amplifiers 248a, 248b, . . . 248n to generate output laser signal 204e.

Another implementation of a semiconductor optical source 2f discloses the entire chip 206f functioning as a master oscillator power amplifier (MOPA) architecture, where a single master oscillator 260 is split by an optical splitter 262 between multiple amplifier sections 258a, 258b, . . . 258n. In this implementation, the entire optical chip 206f may act as a coupled laser resonator. In one implementation phase control 264 may be added to the individual arms to ensure optimal coupling performance to generate output laser signals 204f. In one implementation, the optical splitter 260 is a waveguide splitter including at least one of a y-splitter, Mach-Zehnder splitter, multi-mode interferometer (MMI) splitter, wavelength splitter, or selective switching.

Another implementation of a semiconductor optical source 2g illustrates using waveguide SOAs (semiconductor optical amplifiers) rather than tapered amplifiers. In such implementation, the input signal 202g is split by an optical splitter 270 between multiple waveguide SOAs 268a, 268b, . . . 268n to generate the output laser signals 204g. In one implementation, the optical splitter 270 is a waveguide splitter including at least one of a y-splitter, Mach-Zehnder splitter, multi-mode interferometer (MMI) splitter, wavelength splitter, or selective switching.

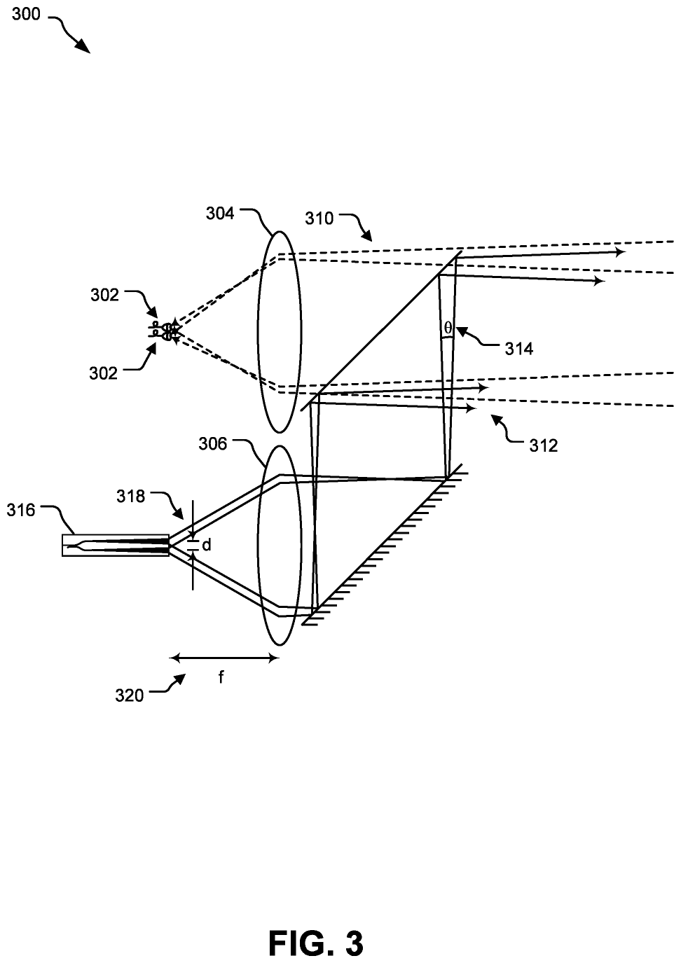

FIG. 3 illustrates an example illustration of the coherent LiDAR system 300 disclosed herein using a bifurcated semiconductor amplifier. Specifically, the LiDAR system 300 includes an SOA 316 with bifurcated and/or tapered waveguides to generate two channels of light that are spatially separated by a distance d 318. A collimation lens 306 having a focal length f 320 collimates the laser signals output from the SOA 316. The collimation of the laser signals results in having an angular separation of θ 314 in angular space between the laser signals reflected by a scanner 310. The angular separation of θ is equal to 2*arctan(1/2*d/f), where fis the focal length of the collimation lens 306 and d is the distance between the two emitting waveguides on the SOA 316.

The laser signals may travel to and be reflected from a target. The reflected laser signals (indicated by dotted lines) are focused on photodiodes 302 and 304 using a focusing lens 304. As the SOA 316 has bifurcated waveguides generating multiple laser signals, these two laser signals are scanned in parallel through the LiDAR system 300, resulting in the range data/sample points that can be collected by the photodiodes 302 and 304. While the implementation in FIG. 3 has the SOA 316 bifurcating an input laser signal, in alternative implementations, an input laser signal may be divided into a higher number of output laser signals that are scanned in parallel through the LiDAR system 300.

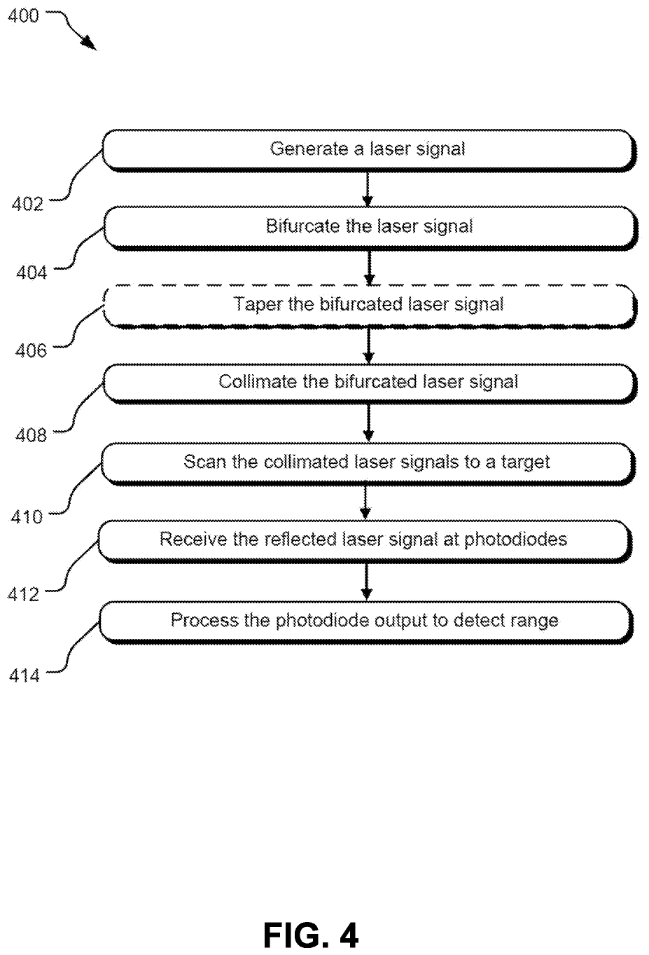

FIG. 4 illustrates an example operations disclosing use of the coherent LiDAR system disclosed herein using bifurcated semiconductor amplifier to increase the channel count. An operation 402 generates a light signal, such as a laser signal. An operation 404 bifurcates the laser signal using an SOA that has bifurcated waveguides. An operation 406 optionally tapers the bifurcated laser signal. The bifurcated laser signal is collimated by a collimation lens at operation 408. An operation 410 scans the collimated laser signal to a target. For example, the collimated laser signal may be scanned to a target using a polygon scanner. An operation 412 receives the laser signal reflected from the target using photodiodes. The output from the photodiodes is processed by a processing operation 414 to detect range of the target.

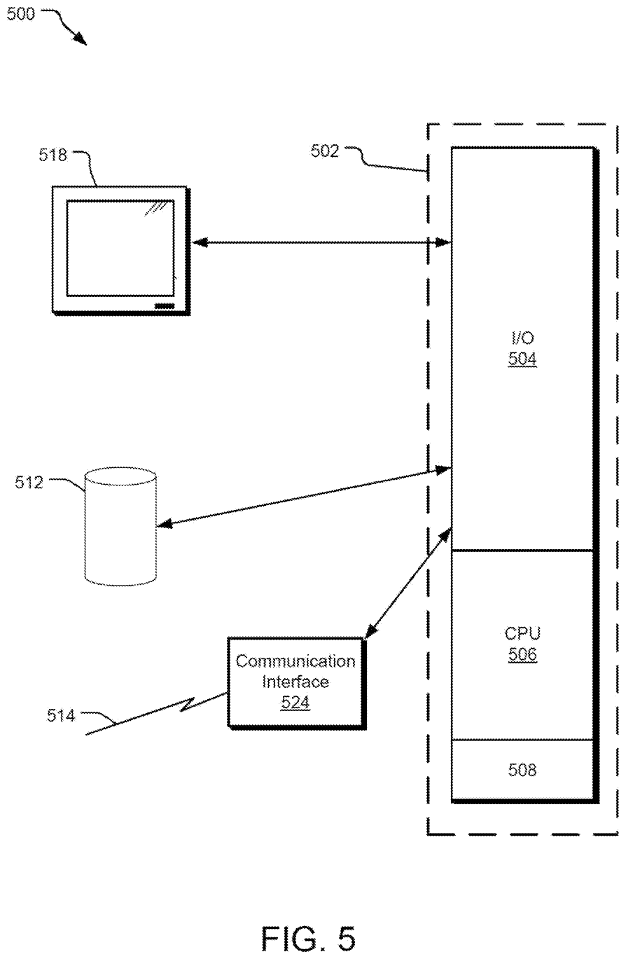

FIG. 5 illustrates an example processing system 500 that may be useful in implementing the described technology. The processing system 500 is capable of executing a computer program product embodied in a tangible computer-readable storage medium to execute a computer process. Data and program files may be input to the processing system 500, which reads the files and executes the programs therein using one or more processors (e.g., CPUs, GPUs, ASICs). Some of the elements of a processing system 500 are shown in FIG. 5 wherein a processing device 502 is shown having an input/output (I/O) section 504, a processing unit 506, and a memory section 508.

In some implementations, an operating system (not shown) may reside in the memory 508 and be executed by the processing unit 506. In other implementations, the processing unit 506 does not execute an operating system during nominal operations. One or more applications (not shown) may reside in the memory 508, such as the digital signal processing unit 130 of FIG. 1. In various implementations, the processing unit 506 could be an application-specific integrated circuit (ASIC), digital signal processor (DSP), system on chip (SoC), central processing unit (CPU) of a general-purpose computer, etc. In some implementations, the processing unit 506 comprises more than one processor. The processor(s) may be single core or multi-core processors. The processing device 502 may be a special purpose computing device, a conventional computer, a distributed computer, or any other type of processing device.

There may be one or more processing devices 502, such that the processing device 502 of the processing system 500 comprises a single processing unit 506, or a plurality of processing units. The processors may be single core or multi-core processors. The processing system 500 may be a conventional computer, a distributed computer, or any other type of computer. The described technology is optionally implemented in software loaded in memory 508, a storage unit 512, and/or communicated via a wired or wireless network link 514 on a carrier signal (e.g., Ethernet, 3G wireless, 5G wireless, LTE (Long Term Evolution)) thereby transforming the processing system 500 in FIG. 5 to a special purpose machine for implementing the described operations. The processing system 500 may be an application specific processing system configured for supporting the disc drive throughput balancing system disclosed herein.

The I/O section 504 may be connected to one or more user-interface devices (e.g., a keyboard, a touch-screen display unit 518, etc.) or a storage unit 512. Computer program products containing mechanisms to effectuate the systems and methods in accordance with the described technology may reside in the memory section 508 or on the storage unit 512 of such a system 500.

A communication interface 524 is capable of connecting the processing system 500 to an enterprise network via the network link 514, through which the computer system can receive instructions and data embodied in a carrier wave. When used in a local area networking (LAN) environment, the processing system 500 is connected (by wired connection or wirelessly) to a local network through the communication interface 524, which is one type of communications device. When used in a wide-area-networking (WAN) environment, the processing system 500 typically includes a modem, a network adapter, or any other type of communications device for establishing communications over the wide area network. In a networked environment, program modules depicted relative to the processing system 500 or portions thereof, may be stored in a remote memory storage device. It is appreciated that the network connections shown are examples of communications devices for and other means of establishing a communications link between the computers may be used.

In an example implementation, a storage controller, and other modules may be embodied by instructions stored in memory 508 and/or the storage unit 512 and executed by the processing device 502. Further, the storage controller may be configured to assist in supporting the RAIDO implementation. A RAID storage may be implemented using a general-purpose computer and specialized software (such as a server executing service software), a special purpose computing system and specialized software (such as a mobile device or network appliance executing service software), or other computing configurations. In addition, keys, device information, identification, configurations, etc. may be stored in the memory 508 and/or the storage unit 512 and executed by the processing device 502.

The processing system 500 may be implemented in a device, such as a user device, storage device, IoT device, a desktop, laptop, computing device. The processing system 500 may be a storage device that executes in a user device or external to a user device.

In addition to methods, the embodiments of the technology described herein can be implemented as logical steps in one or more computer systems. The logical operations of the present technology can be implemented (1) as a sequence of processor-implemented steps executing in one or more computer systems and/or (2) as interconnected machine or circuit modules within one or more computer systems. Implementation is a matter of choice, dependent on the performance requirements of the computer system implementing the technology. Accordingly, the logical operations of the technology described herein are referred to variously as operations, steps, objects, or modules. Furthermore, it should be understood that logical operations may be performed in any order, unless explicitly claimed otherwise or unless a specific order is inherently necessitated by the claim language.

Data storage and/or memory may be embodied by various types of processor-readable storage media, such as hard disc media, a storage array containing multiple storage devices, optical media, solid-state drive technology, ROM, RAM, and other technology. The operations may be implemented processor-executable instructions in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

The embodiments of the disclosed technology described herein are implemented as logical steps in one or more computer systems. The logical operations of the presently disclosed technology are implemented (1) as a sequence of processor-implemented steps executing in one or more computer systems and (2) as interconnected machine or circuit modules within one or more computer systems. The implementation is a matter of choice, dependent on the performance requirements of the computer system implementing the disclosed technology. Accordingly, the logical operations making up the embodiments of the disclosed technology described herein are referred to variously as operations, steps, objects, or modules. Furthermore, it should be understood that logical operations may be performed in any order, adding, and omitting as desired, unless explicitly claimed otherwise or a specific order is inherently necessitated by the claim language.

Implementations described and claimed herein include a LiDAR system with a semiconductor optical amplifier (SOA) configured to receive a light signal from a master-oscillator laser source, the semiconductor optical source including an optical splitter configured to split the light signal into two or more split light signals and two or more respective semiconductor optical amplifiers (SOAs), each SOA configured to receive one of the split light signals and amplify the split light signal.

An apparatus disclosed herein includes a semiconductor optical source configured to receive a light signal from a master-oscillator laser source, the semiconductor optical source including an optical splitter configured to split the light signal into two or more split light signals and two or more respective semiconductor optical amplifiers (SOAs), each SOA configured to receive one of the split light signals and amplify the split light signal, wherein the master-oscillator laser source is integrated into the semiconductor optical source.

A semiconductor optical source device disclosed herein includes an optical splitter configured to split a light signal from a master-oscillator laser source into two or more split light signals and two or more respective semiconductor optical amplifiers (SOAs), each SOA configured to receive one of the split light signals and amplify the split light signal.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A LiDAR system comprising:
a semiconductor optical source configured to receive a light signal from a master-oscillator laser source, the semiconductor optical source comprising:
an optical splitter configured to split the light signal into two or more split light signals; and
two or more respective semiconductor optical amplifiers (SOAs), each SOA configured to receive one of the split light signals and amplify the split light signal.

2. The LiDAR system of claim 1, wherein the master-oscillator laser source is integrated into the semiconductor optical source.

3. The LiDAR system of claim 2, wherein the two or more SOAs, the master-oscillator laser source, and the optical splitter form a coupled-laser system.

4. The LiDAR system of claim 1, wherein the optical splitter is a waveguide splitter comprising at least one of a y-splitter, Mach-Zehnder splitter, multi-mode interferometer (MMI) splitter, wavelength splitter, or selective switching.

5. The LiDAR system of claim 1, wherein each of the SOAs are tapered waveguides.

6. The LiDAR system of claim 5, wherein the SOAs are further configured to increase output power of the light signal traveling through the tapered waveguides.

7. The LiDAR system of claim 1, wherein the master-oscillator laser source is further configured to provide a local oscillator output for use in a coherent detection scheme.

8. The LiDAR system of claim 1, further comprising a collimating lens configured to collimate the amplified light signal emitted by each of the SOAs and to direct the emitted light signal to a scanner.

9. The LiDAR system of claim 1, further comprising an optical image collector configured to collect return light associated with each output and to map the collected return light onto an array of one or more light detectors.

10. An apparatus, comprising:
a semiconductor optical source configured to receive a light signal from a master-oscillator laser source, the semiconductor optical source comprising:
an optical splitter configured to split the light signal into two or more split light signals; and
two or more respective semiconductor optical amplifiers (SOAs), each SOA configured to receive one of the split light signals and amplify the split light signal,
wherein the master-oscillator laser source is integrated into the semi-conductor optical source.

11. The apparatus of claim 10, wherein the two or more SOAs, the master-oscillator laser source, and the optical splitter form a coupled-laser system.

12. The apparatus of claim 10, wherein the optical splitter is a waveguide splitter comprising at least one of a y-splitter, Mach-Zehnder splitter, multi-mode interferometer (MMI) splitter, wavelength splitter, or selective switching.

13. The apparatus of claim 10, wherein each of the SOAs are tapered waveguides.

14. The apparatus of claim 10, wherein the SOAs are further configured to increase output power of the light signal traveling through the tapered waveguides.

15. The apparatus of claim 10, wherein the master-oscillator laser source is further configured to provide a local oscillator output for use in a coherent detection scheme.

16. The apparatus of claim 10, further comprising a collimating lens configured to collimate the amplified light signal emitted by each of the SOAs and to direct the emitted light signal to a scanner.

17. A semiconductor optical source device comprising:
an optical splitter configured to split a light signal from a master-oscillator laser source into two or more split light signals; and
two or more respective semiconductor optical amplifiers (SOAs), each SOA configured to receive one of the split light signals and amplify the split light signal.

18. The semiconductor optical source device of claim 17, wherein the master-oscillator laser source is integrated into the semiconductor optical source.

19. The semiconductor optical source device of claim 17, wherein each of the SOAs are tapered waveguides.

20. The semiconductor optical source device of claim 17, wherein the optical splitter is a waveguide splitter comprising at least one of a y-splitter, Mach-Zehnder splitter, multi-mode interferometer (MMI) splitter, wavelength splitter, or selective switching.
